(19) United States
(12) Patent Application Publication
(10) Pub. No.: US 2006/0291109 A1
(43) Pub. Date: Dec. 28, 2006

(54) Arcing detection system and method for vehicle

(75) Inventor: Yongchang Wang, Azusa, CA (US)

Correspondence Address: Raymond Y. Chan, 108 N. Ynez Ave., #128, Monterey Park, CA, 91754, US

(73) Assignee: I/O Controls Corporation

(21) Appl. No.: 11/165,800

(22) Filed: Jun. 24, 2005

(51) Int. Cl. H02H 3/00

(52) U.S. Cl. 361/5

(57) ABSTRACT

An arcing detection system for a vehicle includes a plurality of detection modules adapted for installing into the vehicle to electrically connect with the loads. Each of the detection modules includes a current sensor for detecting a load current of the load to obtain a detected current, and a main controller communicatively linked to the current sensor to verify the detected current that when the detected current is an arc current, the main controller generates an arcing signal for denoting an arc fault of the respective load.

### BACKGROUND OF THE PRESENT INVENTION

1. Field of Invention

The present invention relates to an electrical system, an more particularly to an arcing detection system and method for an electrical system of a vehicle, which is adapted to detect an arcing in the electrical circuit to give a corresponding response so as to prevent any electrical fire caused by arcing.

2. Description of Related Arts

Every year there are hundreds of electrical fires all around the world due to faulty electrical wiring, such as arc fault. Electrical fires are often caused by loose connections, broken wires, faulty switches or shorted wires in the electrical system. Arc fault is considered as an unintentional electrical discharge characterized by low and erratic current that may ignite combustible materials. Arc fault, which generally occurs in damage wiring, can generate enough heat and sparks to produce ignition and cause electrical fires.

Accordingly, there are two types of arcing in electrical circuits, which are series arcing and parallel arcing. Series arcing is caused by a, a broken wire, faulty switch, or loose connection in series with the load circuit. Series arcing is dangerous and difficult to detect because the arc current is well below the load current in a normal operation. Parallel arcing occurs by shorts to ground, short circuit, or fray wiring abrading metal. Parallel arcing is more hazardous than the series arcing because the arc current is well above the load current to generate a relative large energy in the sparks for producing ignition of nearby combustible materials.

Many arc detection devices, such as thermal breaker or magnetic breaker, are used in household electrical system for preventing arcing failures. Such detection device directly cuts off the load current when arcing occurs. However, such arc detection devices cannot be used in a vehicle. Since the electrical system of the household is an AC electrical system, such arc detection devices cannot be used for the DC electrical system of the vehicle. Therefore, there is no protection for the driver when arcing occurs in the vehicle. The concept of the arc detection device cannot be totally applied on the vehicle because when the load current is broken by the arc detection device, the corresponding component will stop functioning which will cause the vehicle out of control. In addition, the components of the vehicle are linked in a CAN system, when one of the components is switched off, other related components will consequential switched off beyond the point of the breakage in the CAN system.

### SUMMARY OF THE PRESENT INVENTION

A main object of the present invention is to provide an arcing detection system for an electrical system of a vehicle, which is adapted to detect an arcing in the electrical circuit to give a corresponding response so as to prevent any electrical fire caused by arcing.

Another object of the present invention is to provide an arcing detection system, wherein a plurality of current sensors are installed into the vehicle to detect the load currents of the loads such that when any one of the load currents is in an abnormal condition, the current sensor sends out an arc signal with respect to the load to indicate the arcing in the electrical circuit of the load.

Another object of the present invention is to provide an arcing detection system, wherein when the main controller receives the arc signal from the current sensor, the main controller will selectively switch off the corresponding load or generate an alerting signal so as to remain the vehicle under control during driving.

Another object of the present invention is to provide an arcing detection system, which is adapted to detect both series arcing and parallel arcing in the electrical circuit of the load.

Another object of the present invention is to provide an arcing detection system, which is adapted to detect the arc fault even when the load is switched off so as to ensure the safety of the vehicle.

Another object of the present invention is to provide an arcing detection method, which is easy to use and implemented in a user-friendly manner so as to promote wide-spread application of the present invention. In other words, the arcing detection system of the present invention is adapted to incorporate with any DC electrical system.

Another object of the present invention is to provide an arcing detection system, wherein no expensive or complicated electrical structure is required to employ in the present invention in order to achieve the above mentioned objects. Therefore, the present invention successfully provides an economic and efficient solution not only for detecting an arc fault of the vehicle but also for minimizing the electrical fire caused by arcing.

Accordingly, in order to accomplish the above objects, the present invention provides an arcing detection system for a vehicle having a plurality of loads, comprising a plurality of detection modules adapted for installing into the vehicle to electrically connect with the loads, wherein each of the detection modules comprising a current sensor for detecting a load current of the load to obtain a detected current, and a main controller communicatively linked to the current sensor to verify the detected current that when the detected current is an arc current, the main controller generates an arcing signal for denoting an arc fault of the respective load.

The present invention further provides a process of detecting arc fault of a vehicle having a plurality of loads, comprising the steps of:

(a) detecting a load current of each of the loads to obtain a detected current;

(b) verifying the detected current whether the detected current is an arc current; and

(c) generating an arcing signal for denoting an arc fault of the respective load.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of an arcing detection system for a vehicle according to a preferred embodiment of the present invention.

FIG. 2 is a circuit diagram of the arcing detection system according to the above preferred embodiment of the present invention.

FIG. 3 is a flow diagram of a process of detecting arc fault by the arcing detection system according to the above preferred embodiment of the present invention.

FIG. 4 is a block diagram of the arcing detection system incorporated with the vehicle according to the above preferred embodiment of the present invention.

### DETAILED DESCRIPTION OF THE PREFERRED EMBODIMENT

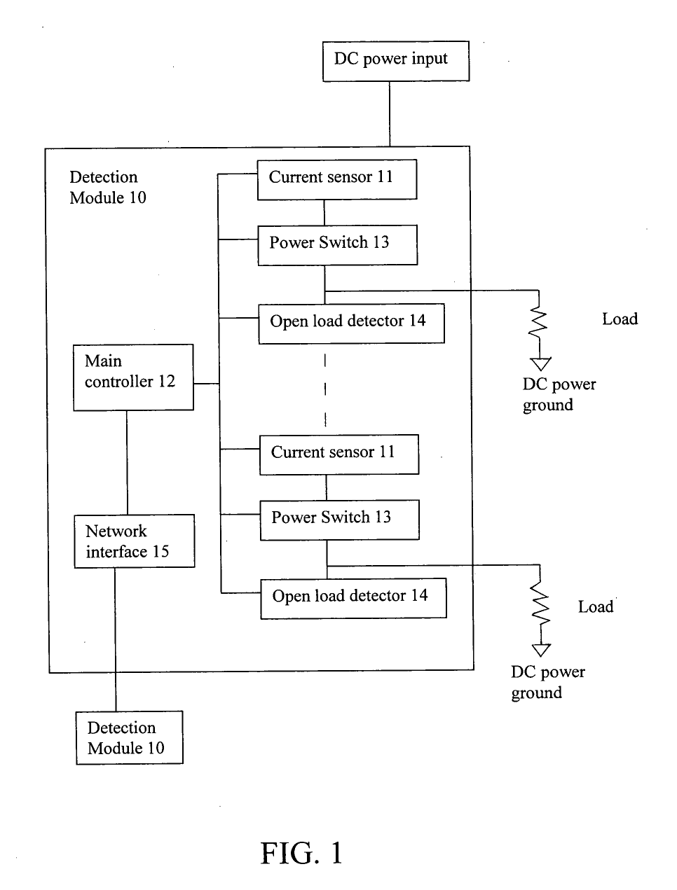

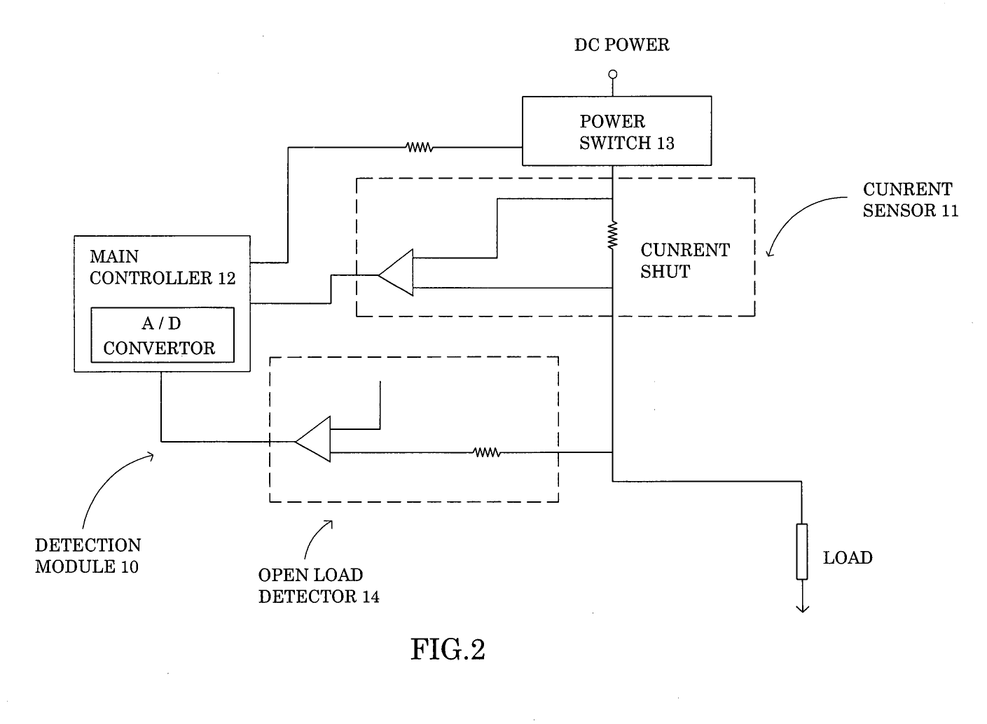

Referring to FIGS. 1 and 2, of the drawings, an arcing detection system according to a preferred embodiment of the present invention is illustrated, wherein the arcing detection system is adapted to incorporate with a vehicle comprising a plurality of loads electrically connected to a power source of the vehicle. Accordingly, the load can be embodied as a power window, a power door lock, a power seat, or a power brake in which the load is electrically wired to the electrical system of the vehicle.

The arcing detection system comprises a plurality of detection modules 10 adapted for installing into the vehicle to electrically connect with the loads, wherein each of the detection modules 10 can be communicatively linked to more than one load such that each detection module 10 is adapted to group the neighboring loads in the vehicle.

Each of the detection modules 10 comprises a current sensor 11 for detecting a load current of the load to obtain a detected current, and a main controller 12 communicatively linked to the current sensor 11 to verify the detected current that when the detected current is an arc current, the main controller 12 generates an arcing signal denoting an arc fault of the respective loads.

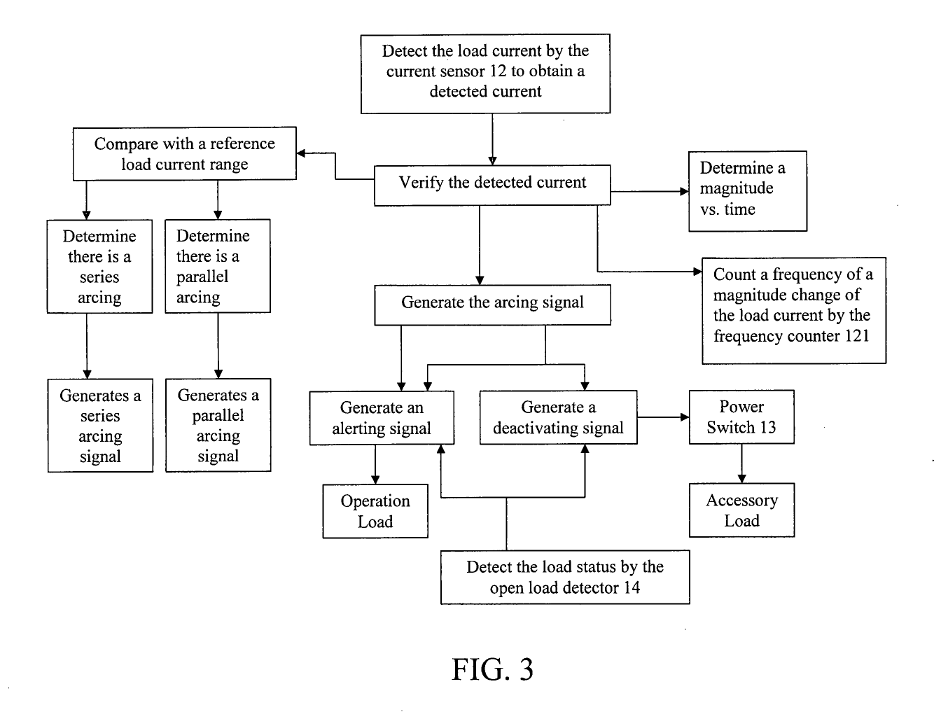

As shown in FIG. 3, the present invention further provides a process of detecting arc fault of a vehicle having a plurality of loads, comprising the following steps.

(1) Detect the load current of each of the loads to obtain the detected current by the current sensor 11.

(2) Verify the detected current whether the detected current is an arc current by the main controller 12.

(3) Generate the arcing signal for denoting an arc fault of the respective load.

According to the preferred embodiment, the detection module 10 can be electrically connected to the power source of the vehicle, such as the vehicle battery, or to an external power supply to prevent the malfunction of the detection module 10 when the power source of the vehicle is out of battery.

The current senor 11 is adapted to communicatively link to more than one load to detect the load current thereof so as to obtain the detected current. The current sensor 11 detects the current status of each of the loads and reports to the main controller 12 to determine the arc fault of the load. The main controller generates the arcing signal when the magnitude of the detected current is out of a reference load current range preset in the main controller 12.

Accordingly, under normal operation, the load current of the load falls within a safety range. When there is an abnormal operation of the load, the load current thereof will fall out of the safety range. In other words, there is a series arcing when the load current of the load is well below the safety range. Likewise, there is a parallel arcing when the load current of the load is well above the safety range. It is worth to mention that the load current is a DC current.

The main controller 12 is embodied as a micro controller wherein the safety range of each of the loads is preset in the main controller 12 such that when the main controller 12 receives the detected current of the sensor 11, the main controller 12 will verify whether the load is normally operated or not.

According to the preferred embodiment, the main controller 12 determines the arc fault is a series arcing or a parallel arcing. The main controller 12 determines there is a series arcing when the detected current is well below the reference load current range (i.e. the normal operation current of the load), wherein the main controller 12 generates a series arcing signal to denote the series arcing of the respective load. The main controller 12 determines there is a parallel arcing when the detected current is well above the reference load current, wherein the main controller 12 generates a parallel arcing signal to denote the parallel arcing of the respective load.

Accordingly, in step (2), the process further comprises the following steps.

(2.1) Determine there is a series arcing when the detected current is well below a reference load current, wherein the main controller 12 generates the series arcing signal to denote the series arcing of the respective load.

(2.2) Determine there is a parallel arcing when the detected current is well above the reference load current, wherein the main controller 12 generates the parallel arcing signal to denote the parallel arcing of the respective load.

It is worth to mention that arcing can be detected when the load current is rapidly changed in a relatively short period of time (i.e. determine the magnitude of said load current vs. time). During the normal operation of the load, the load current is gradually changed for a relatively long period of time. When the current sensor 11 detects a rapid current change, the main controller 12 will verify the detected current as the arcing current to denote the arc fault of the load. In other words, there is an arc fault when the magnitude of the load current is changed rapidly in a short period of time and return back to its original magnitude. For example, the main controller 12 determines there is an arc fault when a 4A load current is changed rapidly to 1A in 1 ms and then returned back to 4A. It is worth to mention that there is a parallel arcing when the magnitude of the load current rapidly jumps up in a short period of time. There is a series arcing when magnitude of the load current rapidly falls down in a short period of time.

Alternatively, the main controller 12 comprises a frequency counter 121 counting a frequency of the magnitude change of the load current to determine the arc fault. Accordingly, some factors, such as noise, will affect the magnitude change of the load current such that an occasional magnitude change of the load current may not be considered as the arc fault. The frequency counter 121 will count the frequency of the magnitude change of the load current that when the frequency of the magnitude change of the load current is more than the reference frequency preset in the main controller 12, the main controller 12 will determine there is an arc fault.

In addition, the main controller 12 comprises an analogy-to-digit (A/D) converter to convert the detected current in a digit form to compare with the reference load current of each of the loads preset in the main controller 12.

Each of the detection modules 10 further comprises a power switch 13 electrically connected to the main controller 12 for controlling each of the loads in an on and off manner. Accordingly, when the main controller 12 verifies the detected current is an arc current, the main controller 12 generates a control signal as the arcing signal to the power switch 13 for deactivating the respective load. It is worth to mention that the power switch 13 is connected to the load as one of the accessory components of the vehicle that the load can be deactivated or switched off anytime without affecting the operation of the vehicle. For example, the power switch 13 is connected to the signal indicator of the vehicle such that when the load current of the signal indicator is abnormal, the signal indicator is deactivated while the vehicle can be normally operation.

When the load as the operation components of the vehicle, such as the power brake or engine, is deactivated to cause a malfunction of the vehicle, the power switch 13 will not be actuated by the main controller 12. The main controller 12 will generate an alerting signal as the arcing signal to only denote the arc fault of the respective load. Therefore, during driving, the driver is able to immediately pull over the vehicle to prevent the electrical fire caused by arcing. In other words, a safety logic regulation is preset in the main controller 12 to determine whether the load is an operation component of the vehicle or not in order to deactivate the load when there is an arc fault thereof.

Accordingly, when the load is one of the accessory components of the vehicle, the process of the present invention, in step (3), further comprises a step of generating an alerting signal and deactivating signal for the respective load of the vehicle when the detected current is an arc current while the vehicle is remained in a normal operation. Alternatively, when the load is one of the necessary components of the vehicle, the process in step (3) comprises a step of generating an alerting signal for the respective load of the vehicle when the detected current is an arc current while the vehicle is remained in a normal operation.

Each of the detection modules 10 further comprises an open load detector 14 communicatively linked to the main controller 12 for detecting the load statue of the load when the load is switched off. Accordingly, the current sensor 11 detects the load current of the load when the load is switched on. The open load detector 14 functions as the current sensor 11 that the open load detector 14 detects load status only when the load is off. In addition, the main controller 12 will receive the detected current from the open load detector 14 to verify whether the normal operation of the load or not. For example, when the vehicle is started, the power window as the load is remained in an off position unless the power window is actuated. Therefore, the open load detector 14 detects the power window when the power window is off. Once the power window is actuated, the current sensor 12 detects the load current of the power window. In other words, the detection module 10 will check whether there is a normal electrical circuit of the load in any case the load is on or off. Therefore, the process further comprises a step of detecting the load status of the load when the load is switched off.

Once the open load detector 14 detects an improper the load status of the load, the main controller 12 will send the alerting signal to notify the abnormal operation of the load if the load is one of the operation components of the vehicle. Likewise, the main controller 12 will send the alerting signal to notify the abnormal operation of the load and deactivate the load via the power switch 13 if the load is one of the accessory components of the vehicle.

Each of the detection modules 10 further comprises a network interface 15 communicatively linked to the main controller 12 to communicatively network with another detection modules 10 to form a detection network for monitoring arc fault of the loads of the vehicle. Accordingly, when the arcing detection system is installed into a truck, more than ten detection modules 10 will be spacedly installed into different areas of the truck such that each of the detection modules 10 is adapted to denote the arc fault of the load within the respective area. Once the detection modules 10 are networked via the network interface 15 to form the detection network, the loads of the truck can be under arcing monitor.

According to the preferred embodiment, the arcing detection system is incorporated with the electrical system of the vehicle, wherein the vehicle generally comprises a plurality of modules carrying the loads, and a central controller communicatively networking with the modules to monitor the operation of each of the modules. The main controller 12 of the present invention is communicatively linked to the central controller of the vehicle to monitor the arc fault of each of the modules.

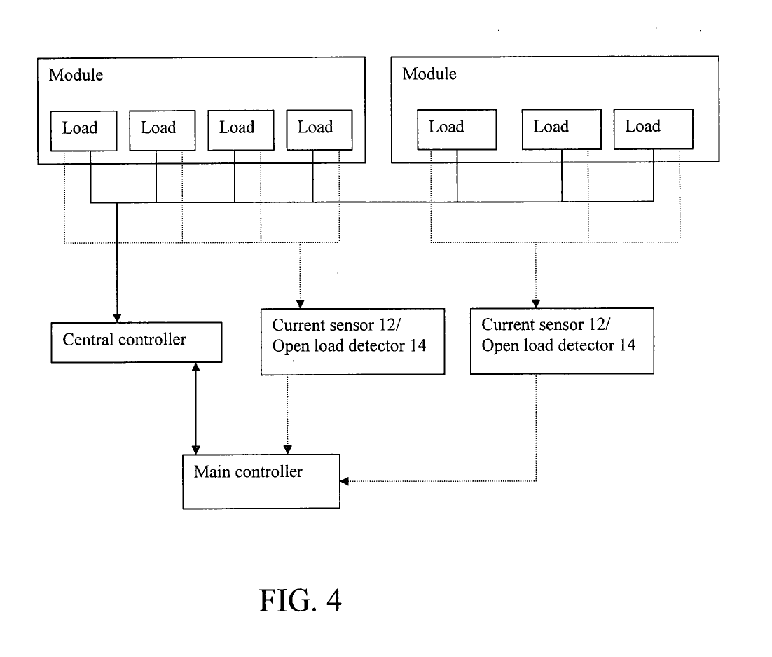

As shown in FIG. 4, the present invention further provides an operation detection of the vehicle comprising the following steps.

(A) Input a monitoring signal to each of the modules from the central controller.

(B) Output a feedback signal from each of the modules to the central controller to determine whether each of the modules is operating normally.

(C) Input an arcing detecting signal from the main control to each of the modules.

(D) Output a responding signal from each of the modules to the main control 12 to determine whether an arc fault occurs at each of the modules.

Accordingly, the step (C) comprises the steps of:

(1) Detect the load current of each of the loads to obtain the detected current by the current sensor 11.

(2) Verify the detected current whether the detected current is an arc current by the main controller 12.

(3) Generate the arcing signal for denoting an arc fault of the respective load.

In step (D), the main controller 12 determines the module is an operation component of the vehicle or an accessory component thereof in order to send out the alerting signal only or deactivate the load of the module with the alerting signal. It is worth to mention that the arcing detection system of the present invention will check all modules of the vehicle including the arcing detection system itself to determine the arc fault thereof.

Accordingly, in step (B), the feedback signal determines whether the load is on or off. As the example mentioned above, when the power of the vehicle is started, the central controller checks the output of the power window to determine the power window is on while being actuated. Therefore, the current sensor 11 detects the current load when the module is on in step (B), while the open load detector 14 detects the load status when the module is off in step (B).

It is worth to mention that the arcing detection system of the present invention is adapted to not only incorporate with the electrical system of the vehicle but also communicatively link to any DC electrical distribution system.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An arcing detection system for a vehicle having a plurality of loads, comprising a plurality of detection modules adapted for installing into the vehicle to electrically connect with the loads, wherein each of the detection modules comprising a current sensor for detecting a load current of said load to obtain a detected current thereof, and a main controller communicatively linked to the current sensor to verify the detected current that when the detected current is an arc current, the main controller generates an arcing signal for denoting an arc fault of the respective load.

2. The arcing detection system, as recited in claim 1, wherein said main controller generates said arcing signal when a magnitude of said detected current is out of a reference load current range preset in said main controller.

3. The arcing detection system, as recited in claim 2, wherein said main controller generates a series arcing signal for denote said series arcing of said respective load when said main controller determines there is a series arcing that said detected current is below said reference load current range, wherein said main controller generates a parallel arcing signal for denote said parallel arcing of said respective load when said main controller determines there is a parallel arcing that said detected current is above said reference load current range.

4. The arcing detection system, as recited in claim 1, wherein each of said detection modules further comprises a power switch electrically connected to said main controller for controlling each of said loads in an on and off manner, wherein when said main controller verifies said detected current is said arc current, said power switch is activated for deactivating said respective load of said vehicle while said vehicle is remained in a normal operation.

5. The arcing detection system, as recited in claim 2, wherein each of said detection modules further comprises a power switch electrically connected to said main controller for controlling each of said loads in an on and off manner, wherein when said main controller verifies said detected current is said arc current, said power switch is activated for deactivating said respective load of said vehicle while said vehicle is remained in a normal operation.

6. The arcing detection system, as recited in claim 3, wherein each of said detection modules further comprises a power switch electrically connected to said main controller for controlling each of said loads in an on and off manner, wherein when said main controller verifies said detected current is said arc current, said power switch is activated for deactivating said respective load of said vehicle while said vehicle is remained in a normal operation.

7. The arcing detection system, as recited in claim 1, wherein when said main controller verifies said detected current is said arc current, said main controller generates an alerting signal while said vehicle is remained in a normal operation.

8. The arcing detection system, as recited in claim 2, wherein when said main controller verifies said detected current is said arc current, said main controller generates an alerting signal while said vehicle is remained in a normal operation.

9. The arcing detection system, as recited in claim 3, wherein when said main controller verifies said detected current is said arc current, said main controller generates an alerting signal while said vehicle is remained in a normal operation.

10. The arcing detection system, as recited in claim 1, wherein each of said detection modules further comprises an open load detector communicatively linked to said main controller for detecting a load status of said load when said load is off.

11. The arcing detection system, as recited in claim 2, wherein each of said detection modules further comprises an open load detector communicatively linked to said main controller for detecting a load status of said load when said load is off.

12. The arcing detection system, as recited in claim 6, wherein each of said detection modules further comprises an open load detector communicatively linked to said main controller for detecting a load status of said load when said load is off.

13. The arcing detection system, as recited in claim 9, wherein each of said detection modules further comprises an open load detector communicatively linked to said main controller for detecting a load status of said load when said load is off.

14. The arcing detection system, as recited in claim 1, wherein said main controller generates said arcing signal when a magnitude of the load current is changed rapidly in a relatively short period of time and return back to its original magnitude.

15. The arcing detection system, as recited in claim 14, wherein each of said detection modules further comprises a power switch electrically connected to said main controller for controlling each of said loads in an on and off manner, wherein when said main controller verifies said detected current is said arc current, said power switch is activated for deactivating said respective load of said vehicle while said vehicle is remained in a normal operation.

16. The arcing detection system, as recited in claim 14, wherein when said main controller verifies said detected current is said arc current, said main controller generates an alerting signal while said vehicle is remained in a normal operation.

17. The arcing detection system, as recited in claim 14, wherein each of said detection modules further comprises an open load detector communicatively linked to said main controller for detecting a load status of said load when said load is off.

18. The arcing detection system, as recited in claim 15, wherein each of said detection modules further comprises an open load detector communicatively linked to said main controller for detecting a load status of said load when said load is off.

19. The arcing detection system, as recited in claim 16, wherein each of said detection modules further comprises an open load detector communicatively linked to said main controller for detecting a load status of said load when said load is off.

20. The arcing detection system, as recited in claim 1, wherein said main controller comprises a frequency counter counting a frequency of a magnitude change of said load current to generate said arcing signal.

21. The arcing detection system, as recited in claim 20, wherein each of said detection modules further comprises a power switch electrically connected to said main controller for controlling each of said loads in an on and off manner, wherein when said main controller verifies said detected current is said arc current, said power switch is activated for deactivating said respective load of said vehicle while said vehicle is remained in a normal operation.

22. The arcing detection system, as recited in claim 20, wherein when said main controller verifies said detected current is said arc current, said main controller generates an alerting signal while said vehicle is remained in a normal operation.

23. The arcing detection system, as recited in claim 20, wherein each of said detection modules further comprises an open load detector communicatively linked to said main controller for detecting a load status of said load when said load is off.

24. The arcing detection system, as recited in claim 21, wherein each of said detection modules further comprises an open load detector communicatively linked to said main controller for detecting a load status of said load when said load is off.

25. The arcing detection system, as recited in claim 22, wherein each of said detection modules further comprises an open load detector communicatively linked to said main controller for detecting a load status of said load when said load is off.

26. The arcing detection system, as recited in claim 1, wherein each of said detection modules further comprises a network interface communicatively linked to said main controller to communicatively network with another said detection module to form a detection network for monitoring arc fault of said loads of said vehicle.

27. The arcing detection system, as recited in claim 13, wherein each of said detection modules further comprises a network interface communicatively linked to said main controller to communicatively network with another said detection module to form a detection network for monitoring arc fault of said loads of said vehicle.

28. The arcing detection system, as recited in claim 19, wherein each of said detection modules further comprises a network interface communicatively linked to said main controller to communicatively network with another said detection module to form a detection network for monitoring arc fault of said loads of said vehicle.

29. The arcing detection system, as recited in claim 25, wherein each of said detection modules further comprises a network interface communicatively linked to said main controller to communicatively network with another said detection module to form a detection network for monitoring arc fault of said loads of said vehicle.

30. A process of detecting arc fault of a vehicle having a plurality of loads, comprising the steps of:
(a) detecting a load current of each of said loads to obtain a detected current;
(b) verifying said detected current whether said detected current is an arc current; and
(c) generating an arcing signal for denoting an arc fault of said respective load.

31. The process as recited in claim 30, in step (b), further comprising a step of determining a magnitude of said detected current with respect to a reference load current range, wherein said arcing signal is generated when said magnitude of said detected current is out of said reference load current range.

32. The process as recited in claim 31, in step (b), further comprising the steps of:
(b.1) determining there is a series arcing when said detected current is below said reference load current range; and
(b.2) determining there is a parallel arcing when said detected current is above said reference load current range.

33. The process as recited in claim 30, in step (c), further comprising a step of deactivating said respective load of said vehicle when said detected current is an arc current while said vehicle is remained in a normal operation.

34. The process as recited in claim 32, in step (c), further comprising a step of deactivating said respective load of said vehicle when said detected current is an arc current while said vehicle is remained in a normal operation.

35. The process as recited in claim 30, in step (c), further comprising a step of generating an alerting signal for said respective load of said vehicle when said detected current is an arc current while said vehicle is remained in a normal operation.

36. The process as recited in claim 32, in step (c), further comprising a step of generating an alerting signal for said respective load of said vehicle when said detected current is an arc current while said vehicle is remained in a normal operation.

37. The process, as recited in claim 30, further comprising a step of detecting a load status of said load when said load is off.

38. The process, as recited in claim 33, further comprising a step of detecting a load status of said load when said load is off.

39. The process, as recited in claim 35, further comprising a step of detecting a load status of said load when said load is off.

40. The process as recited in claim 30, in step (b), further comprising a step of determining a magnitude of said load current vs. time, wherein said arcing signal is generated when said magnitude of the load current is changed rapidly in a relatively short period of time and return back to its original magnitude.

41. The process as recited in claim 40, in step (c), further comprising a step of deactivating said respective load of said vehicle when said detected current is an arc current while said vehicle is remained in a normal operation.

42. The process as recited in claim 40, in step (c), further comprising a step of generating an alerting signal for said respective load of said vehicle when said detected current is an arc current while said vehicle is remained in a normal operation.

43. The process, as recited in claim 40, further comprising a step of detecting a load status of said load when said load is off.

44. The process, as recited in claim 41, further comprising a step of detecting a load status of said load when said load is off.

45. The process, as recited in claim 42, further comprising a step of detecting a load status of said load when said load is off.

46. The process as recited in claim 30, in step (b), further comprising a step of counting a frequency of a magnitude change of said load current to generate said arcing signal.

47. The process as recited in claim 46, in step (c), further comprising a step of deactivating said respective load of said vehicle when said detected current is an arc current while said vehicle is remained in a normal operation.

48. The process as recited in claim 46, in step (c), further comprising a step of generating an alerting signal for said respective load of said vehicle when said detected current is an arc current while said vehicle is remained in a normal operation.

49. The process, as recited in claim 46, further comprising a step of detecting a load status of said load when said load is off.

50. The process, as recited in claim 47, further comprising a step of detecting a load status of said load when said load is off.

51. The process, as recited in claim 48, further comprising a step of detecting a load status of said load when said load is off.

52. A process of detecting an operation of a vehicle which comprises a central controller communicatively networked with a plurality of loads, comprising the steps of:
(a) inputting a monitoring signal to each of said loads from said central controller;
(b) outputting a feedback signal from each of said loads to said central controller;
(c) inputting an arcing detecting signal to each of said loads; and
(d) outputting a responding signal from each of said modules to determine whether an arc fault occurs at each of said loads.

53. The process as recited in claim 52, in step (c), further comprising the steps of:
(c.1) detecting a load current of each of said loads to obtain a detected current;
(c.2) verifying said detected current whether said detected current is an arc current; and
(c.3) generating an arcing signal for denoting an arc fault of said respective load.

54. The process as recited in claim 53, in step (c.2), further comprising a step of determining a magnitude of said detected current with respect to a reference load current range, wherein said arcing signal is generated when said magnitude of said detected current is out of said reference load current range.

55. The process as recited in claim 53, in step (c.2), further comprising a step of determining a magnitude of said load current vs. time, wherein said arcing signal is generated when said magnitude of the load current is changed rapidly in a relatively short period of time and return back to its original magnitude.

56. The process as recited in claim 53, in step (c.2), further comprising a step of counting a frequency of a magnitude change of said load current to generate said arcing signal.

57. The process as recited in claim 53, in step (c.3), further comprising a step of deactivating said respective load of said vehicle when said detected current is an arc current while said vehicle is remained in a normal operation.

58. The process as recited in claim 53, in step (c.3), further comprising a step of generating an alerting signal for said respective load of said vehicle when said detected current is an arc current while said vehicle is remained in a normal operation.

59. The process, as recited in claim 53, further comprising a step of detecting a load status of said load when said load is off.
